(19) United States
(12) Patent Application Publication
(10) Pub. No.: US 2003/0200663 A1
(43) Pub. Date: Oct. 30, 2003

(54) One-handed cutter for acoustic tile borders

(76) Inventors: Phillip K. Clanton, Columbia, TN (US); Samuel S. Clanton, Columbia, TN (US)

Correspondence Address: Richard C. Litman, LITMAN LAW OFFICES, LTD., P.O. Box 15035, Arlington, VA, 22215, US

(21) Appl. No.: 10/128,432

(22) Filed: Apr. 24, 2002

(51) Int. Cl. B26B 29/06

(52) U.S. Cl. 30/294; 30/289

(57) ABSTRACT

A hand-sized, compact tool utilized to cut a ninety degree notch in the edge of sheet material, such as an acoustic ceiling tile, in one easy motion. The tool is designed with a rounded outer surface that is ergonomic and may be fabricated from high density plastic or metal material. The tool employs a pair of standard cutting blades having cutting edges oriented perpendicularly to each other. The tool's unique design assures safety in that the cutting edges are positioned inside a guide groove and are thus, unexposed. Comprising only three parts, the tool may quickly and easily be disassembled to replace worn or broken cutting blades.

### BACKGROUND OF THE INVENTION

1. Field of the Invention

The present invention generally relates to hand tools. More specifically, the present invention is drawn to a tool utilized to cut a ninety degree notch in the edge of an acoustic ceiling tile.

2. Description of the Related Art

Installation of recessed acoustic tile can become tedious when the installer has to cut the border tile to the correct size. The cutting process involves providing a ninety degree notch at the edge of a tile to obtain a proper fit with the adjacent wall. The prior art discloses an array of tools for accomplishing this function. For example, U.S. Pat. No. 4,578,865 (Keller) shows a tool for notching or making a rabbet edge on a ceiling tile. It is noted that two cuts are required to produce the edge.

U.S. Pat. No. 5,048,188 (Wolff) is drawn to a cutting tool for making a rabbet cut. The tool of the instant patent employs a single blade and requires two cuts to achieve the desired edge.

U.S. Pat. No. 1,995,887 (Kimble) shows a notching tool utilizing a pair of blades. However, the tool lacks a guide for holding the tool against the edge of the tile during the cutting process.

The rabbet cutter as disclosed in U.S. Pat. No. 4,777,724 (Sirchia) is made of thirteen separate parts the plurality of which adds to the cost of manufacturing. Also, the cutting blades are dangerously exposed.

U.S. Pat. Nos. 4,495,697 (Ruff) and 3,478,427 (Tims, Jr.) display hand tools for making straight cuts along the edges of sheet material. The tools require only a single blade and neither patentee contemplates forming a notch in the edge of the material.

U.S. Pat. Nos. 4,180,908 (Beerman), 2,038,884 (Chalmer) and 1,624,136 (Goldblatt) disclose tools for cutting V-shaped and/or circular grooves in the surface of a material.

U.S. Pat. No. Des. 332,737 (Wentworth et al.) is drawn to a design for a ceiling knife which utilizes a single blade.

U.S. Pat. No. 3,644,993 (Chupp) discloses a device for trimming the edge of an object and includes a hand held tool which has a guide portion thereon. The tool uses a single blade and cannot manipulate to form a notch.

None of the above inventions and patents, taken either singularly or in combination, is seen to disclose a tile cutter as will subsequently be described and claimed in the invention.

### SUMMARY OF THE INVENTION

The instant invention is a hand-sized, compact tool utilized to cut a ninety degree notch in the edge of sheet material, such as an acoustic ceiling tile, in one easy motion. The tool is designed with a rounded outer surface that is ergonomic and may be fabricated from high-density plastic or metal material. The tool employs a pair of standard carpet cutting blades having cutting edges oriented perpendicularly to each other. The tool's unique design assures safety in that the cutting edges are positioned inside a guide groove and are thus, unexposed. Comprising only three parts, the tool may quickly and easily be disassembled to replace worn or broken cutting blades.

Accordingly, it is a principal object of the invention to provide a compact hand tool, which tool can be used to enhance the installation of ceiling tile.

It is another object of the invention to provide a compact hand tool, which tool can be utilized to cut a ninety degree notch at the edge of a ceiling tile.

It is a further object of the invention to provide a compact hand tool, which tool is safe to use.

Still another object of the invention is to provide a compact hand tool, which tool comprises a minimum number of parts.

It is an object of the invention to provide improved elements and arrangements thereof for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental, perspective view of a one-handed cutter for tile borders according to the present invention.

FIG. 2 is an exploded, perspective view of a one-handed cutter for tile borders according to the present invention.

FIG. 3 is a front view of a one-handed cutter for tile borders according to the present invention.

Similar reference characters denote corresponding features consistently throughout the attached drawings.

### DETAILED DESCRIPTION OF THE PREFERRED EMBODIMENT

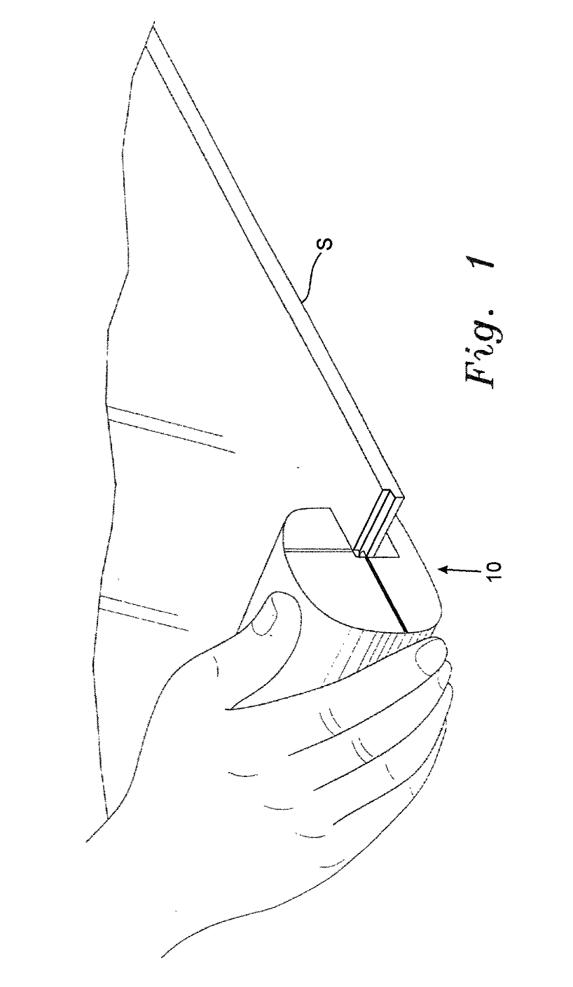

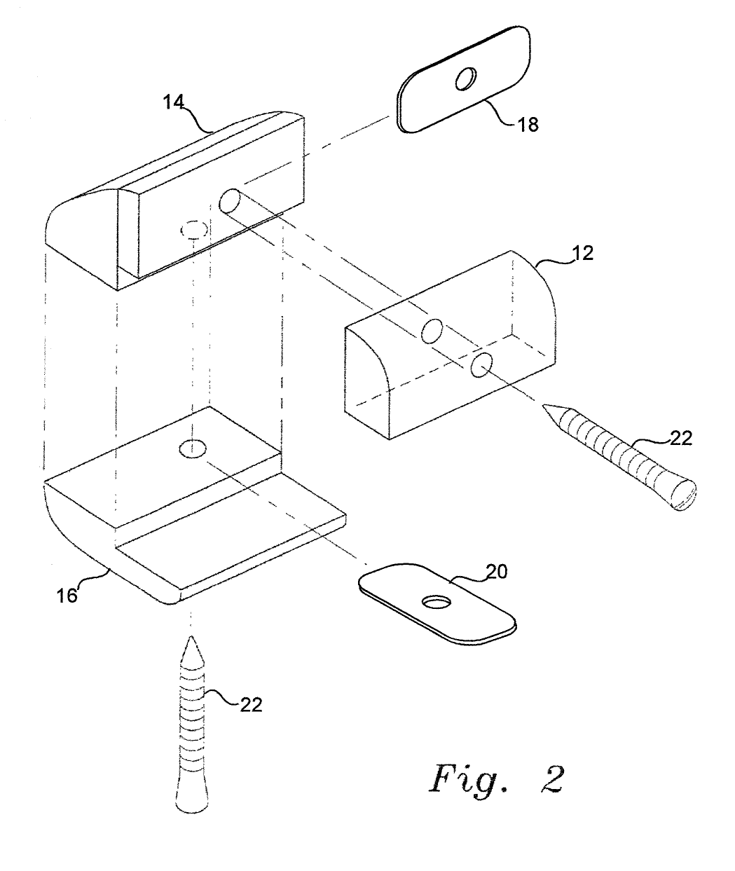

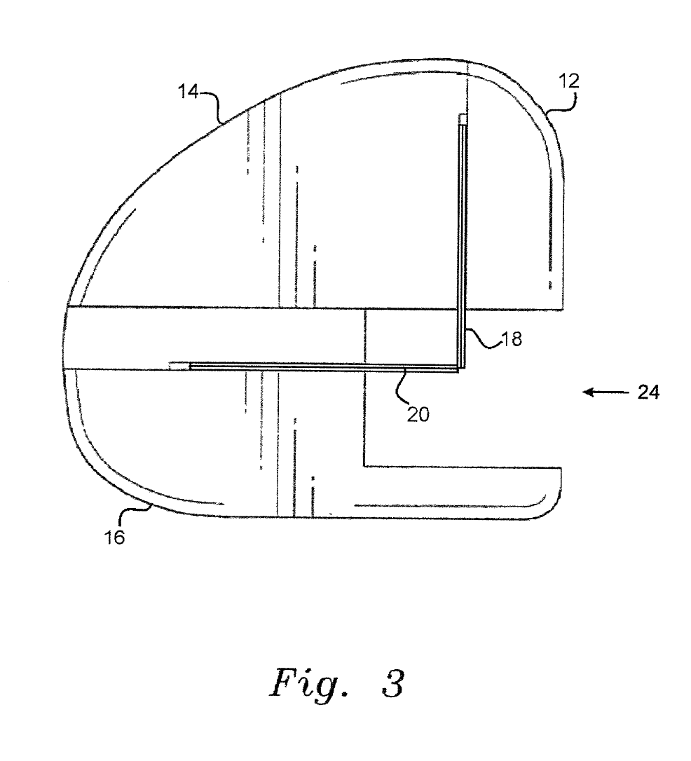

Attention is directed to FIGS. 1-3 wherein the cutting tool of the present invention is generally indicated at 10. As shown in FIG. 1, cutting tool 10 is utilized to cut a ninety degree notch at the edge of ceiling tile S. Cutter 10 is an uncomplicated tool and as best seen in FIG. 2, comprises only three major parts 12, 14 and 16. Parts 12, 14 and 16 are preferably fabricated from either high density plastic or metal material. Two conventional carpet cutting blades 18, 20 are respectively disposed between parts 12 and 14 and parts 14 and 16. The three major parts and cutting blades are assembled with two screws 22. When assembled (FIG. 3), the three parts present a cutting tool with a rounded, ergonomic outer surface. A guide groove 24 is defined by the assembled parts. The assembled tool is approximately five and three-fourths inches long, one and two-thirds inches wide and two and one-fourth inches at its highest point. Guide groove 24 forms an opening which is approximately three-fourths of an inch high and seven-eighths of an inch deep. The guide groove is configured to accept an edge of a ceiling tile. Groove 24 is coextensive with the length of the assembled tool. In its assembled state cutting blades 18, 20 are positioned in groove 24 such that their respective cutting edges are disposed at a ninety degree angle to each other (FIG. 3). Since the cutting blades are nested within the guide groove, the danger of a cutting injury is appreciably lessened. As noted above, a tile may be notched in one easy motion. The size of the tool is such that it may be safely carried in a pouch or pocket. Worn blades can be quickly and easily replaced simply by removing two screws.

It is to be understood that the present invention is not limited to the embodiment described above, but encompasses any and all embodiments within the scope of the following claims.

We claim:

1. A one-handed cutter for tile borders comprising:
a body member, said body member having separable first, second and third body portions each of said body portions having rounded outer surfaces;
a guide groove formed by said body portions, said guide groove having an opening at said outer surfaces;
a first cutting blade having a first cutting edge, said first cutting blade disposed between said first and said second body portions and said first cutting edge positioned within said guide groove; and
a second cutting blade having a second cutting edge, said second cutting blade disposed between said second and said third body portions and said second cutting edge positioned within said guide groove.

2. A one-handed cutter for tile borders as recited in claim 1, wherein said first cutting edge and said second cutting edge are arranged within said guide groove orthogonally with respect to each other.

3. A one-handed cutter for tile borders as recited in claim 2, including a first fastener for securing said first and second body portions to each other.

4. A one-handed cutter for tile borders as recited in claim 3, including a second fastener for securing said second and third body portions to each other.

5. A one-handed cutter for tile borders as recited in claim 4, wherein said first fastener and said second fastener are screws.

6. A one-handed cutter for tile borders as recited in claim 5, wherein said first, second and third body portions are fabricated from high density plastic material.

7. A one-handed cutter for tile borders as recited in claim 5, wherein said first, second and third body portions are fabricated from metallic material.

8. A one-handed cutter for tile borders comprising:
a body member having a length, a width and a height, said body member having separable first, second and third body portions each of said body portions having rounded outer surfacesn opening at said outer surfaces;
a first cutting blade having a first cutting edge, said first cutting blade disposed between said first and said second body portions and said first cutting edge positioned within said guide groove; and
a second cutting blade having a second cutting edge, said second cutting blade disposed between said second and said third body portions and said second cutting edge positioned within said guide groove.

9. A one-handed cutter for tile borders as recited in claim 8, wherein said length, width and height of said body member are approximately five and three fourths inches, one and two thirds inches and two and one fourth inches respectively.

10. A one-handed cutter for tile borders as recited in claim 9, wherein said height and said depth of said guide groove are approximately three fourths of an inch and seven eighths of an inch respectively.

11. A one-handed cutter for tile borders as recited in claim 10, wherein said length of said guide groove is coextensive with said length said body member.

12. A one-handed cutter for tile borders as recited in claim 11, wherein said first cutting edge and said second cutting edge are arranged within said guide groove orthogonally with respect to each other.

13. A one-handed cutter for tile borders as recited in claim 12, including a first fastener for securing said first and second body portions to each other.

14. A one-handed cutter for tile borders as recited in claim 13, including a second fastener for securing said second and third body portions to each other.

15. A one-handed cutter for tile borders as recited in claim 14, wherein said first fastener and said second fastener are screws.

16. A one-handed cutter for tile borders as recited in claim 15, wherein said first, second and third body portions are fabricated from high density plastic material.

17. A one-hand cutter for tile borders as recited in claim 15, wherein said first, sated from metallic material.
